(19) United States
(12) Patent Application Publication
(10) Pub. No.: US 2026/0229132 A1
(43) Pub. Date: Aug. 6, 2026

(54) INFORMATION PROCESSING DEVICE, INFORMATION PROCESSING METHOD, AND PROGRAM

(71) Applicant: NEC Corporation, Tokyo (JP)

(72) Inventors: Koki SAKAI, Tokyo (JP); Nozomi MATSUMOTO, Tokyo (JP); Takuya NOMURA, Tokyo (JP); Taichi SEISHI, Tokyo (JP); Takumi KAMIYAMA, Tokyo (JP); Kota TANIZAWA, Tokyo (JP); Shuhei MIZUGUCHI, Tokyo (JP)

(73) Assignee: NEC Corporation, Tokyo (JP)

(21) Appl. No.: 19/151,431

(22) PCT Filed: Jan. 29, 2024
(86) PCT No.: PCT/JP2024/002588

§ 371 Date: Jul. 28, 2025

(30) Foreign Application Priority Data
Feb. 10, 2023 (JP) 2023-019536

(51) Int. Cl. G08G 5/57; G06V 20/17; G06V 20/54; G08G 1/01; G08G 1/07; G08G 1/16; H04W 4/40

(52) U.S. Cl. CPC G08G 5/57; G06V 20/17; G06V 20/54; G08G 1/0108; G08G 1/0133; G08G 1/0145; G08G 1/07; G08G 1/164; G08G 1/166; H04W 4/40

(57) ABSTRACT

This information processing device governs a process performed by a base station that is capable of directly and wirelessly communicating with a moving system having a camera within a communication network for direct wireless communication. The information processing device comprises at least one memory storing instructions, and at least one processor configured to execute the instructions to acquire predetermined attention information from a terminal that is directly and communicably connected within the communication network, calculate a first index indicating the possibility that an event to be warned occurs based on the attention information, and specify a warning region having the possibility that the event occurs based on the attention information, in a case where the first index is equal to or greater than a first threshold, and output a movement control signal for giving an instruction to image the specified warning region, to the moving system.

### TECHNICAL FIELD

The present disclosure relates to an information processing device, an information processing method, and a program.

### BACKGROUND ART

A system has been developed that acquires traffic information or the like of a predetermined region from a moving system so as to monitor the region.

A traffic signal system described in Patent Literature 1 communicates with a computing network via a communication system. A mobile device also communicates with the computing network via the communication system. Next, the computing network adaptively controls the traffic signal system by using a location of the mobile device.

A control system described in Patent Literature 2 includes a security device, a moving system, and a control device. The security device detects an abnormality occurred in a monitoring area. The moving system confirms a state of the abnormality by rushing to an occurrence position of the abnormality and imaging the occurrence position. The control device connects each moving system and the security device via a communication network. The control device searches for a moving system that can appropriately image the occurrence position, from among the plurality of moving systems monitoring inside of the monitoring area, based on a notification from the security device, and instructs the moving system obtained from the search result to image the occurrence position via the communication network.

In a system described in Patent Literature 3, an IP camera that can image a video is installed near an intersection where a traffic light is disposed, a moving object extraction process is executed for each predetermined time on the captured image, speed information of the extracted moving object is obtained, and an abnormal traffic state is detected. In a case where an abnormal traffic state is detected, this system forces to change a signal state of the traffic light to, for example, a red light, via a traffic light control board.

### CITATION LIST

### Patent Literature

Patent Literature 1: JP 2020-502718 A
Patent Literature 2: JP 2019-179527 A
Patent Literature 3: JP 2005-309705 A

### SUMMARY OF INVENTION

However, with the above-described technology, even in a case where an abnormality does not actually occur, a process similar to that in a case where the abnormality occurs may be executed, and on the other hand, there is a possibility that the abnormality is not accurately detected even though the abnormality occurs.

An object of the present disclosure is to provide an information processing device or the like that suitably monitors a situation of a predetermined region, in view of the above problems.

An information processing device according to the present disclosure controls a process performed by a base station that can directly and wirelessly communicate with a moving system that includes a camera within a communication network of direct wireless communication. The information processing device includes an attention information acquisition unit, a calculation unit, and a control unit. The attention information acquisition unit acquires predetermined attention information from a terminal that is directly and communicably connected within the communication network. The calculation unit calculates a first index indicating a possibility that an event to be warned occurs based on the attention information. In a case where the first index is equal to or greater than a first threshold, the control unit specifies a warning region having the possibility that the event occurs based on the attention information and outputs a movement control signal for giving an instruction to image the specified warning region to the moving system.

An information processing method according to the present disclosure executes the following process by a computer that is capable of directly and wirelessly communicating with a moving system that includes a camera within a communication network of direct wireless communication. The computer acquires predetermined attention information from a terminal that is directly and communicably connected within the communication network. The computer calculates a first index indicating a possibility that an event to be warned occurs based on the attention information. In a case where the first index is equal to or greater than a first threshold, the computer specifies a warning region having the possibility that the event occurs based on the attention information and outputs a movement control signal for giving an instruction to image the specified warning region to the moving system.

A program according to the present disclosure causes a computer that is capable of directly and wirelessly communicating with a moving system that includes a camera within a communication network of direct wireless communication to execute the following process. The computer acquires predetermined attention information from a terminal that is directly and communicably connected within the communication network. The computer calculates a first index indicating a possibility that an event to be warned occurs based on the attention information. In a case where the first index is equal to or greater than a first threshold, the computer specifies a warning region having the possibility that the event occurs based on the attention information and outputs a movement control signal for giving an instruction to image the specified warning region to the moving system.

According to the present disclosure, it is possible to provide an information processing device, an information processing method, and a program that suitably monitors a situation of a predetermined region.

### BRIEF DESCRIPTION OF DRAWINGS

FIG. 1 is a block diagram of an information processing device according to an example embodiment.

FIG. 2 is a flowchart of an information processing method according to the example embodiment.

FIG. 3 is a diagram around a base station including the information processing device according to the example embodiment.

FIG. 4 is a block diagram of an information processing system according to the example embodiment.

FIG. 5 is a block diagram of a signal post including the information processing device.

FIG. 6 is a block diagram of a moving system according to the example embodiment.

FIG. 7 is a block diagram of a communication terminal according to the example embodiment.

FIG. 8 is a flowchart of the information processing method according to the example embodiment.

FIG. 9 is a block diagram of the information processing system according to the example embodiment. FIG. 10 is a block diagram of the moving system according to the example embodiment.

FIG. 11 is a block diagram of a management terminal according to the example embodiment.

FIG. 12 is a block diagram illustrating a hardware configuration of a computer.

### EXAMPLE EMBODIMENT

Hereinafter, the present invention will be described through example embodiments of the invention, but the invention according to the claims is not limited to the following example embodiments. In addition, not all the configurations described in the example embodiments are essential as means for solving the problem. For clarity of description, the following description and drawings are omitted and simplified as appropriate. In each drawing, the same elements are denoted by the same reference numerals, and redundant description is omitted as necessary.

### First Example Embodiment

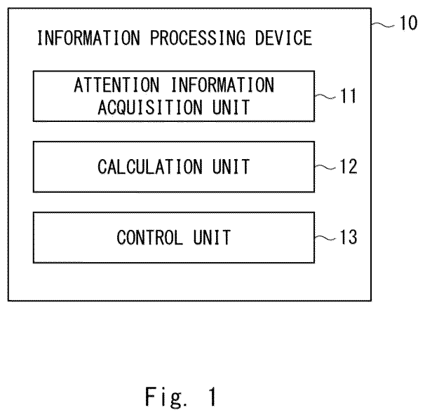

Hereinafter, the present example embodiment will be described with reference to the drawings. FIG. 1 is a block diagram of an information processing device 10 according to a first example embodiment. This information processing device 10 controls a process performed by a base station that can directly and wirelessly communicate with a moving system that includes a camera within a communication network of direct wireless communication. The information processing device 10 may include a circuit including an arithmetic device attached to the base station. The information processing device 10 may be a computer connected to the base station.

The base station is communicably connected to the moving system by direct wireless communication within the communication network. The moving system includes the camera and is set to be capable of transmitting image data to the base station. The information processing device 10 includes an attention information acquisition unit 11, a calculation unit 12, and a control unit 13, as main components.

The attention information acquisition unit 11 acquires predetermined attention information from a terminal that is directly and communicably connected within the communication network. The terminal that is directly and communicably connected is any terminal that can perform direct wireless communication with the base station. The predetermined attention information is information indicating a possibility that an event such as an accident has occurred. The predetermined attention information may be image data or sound or another data indicating whether vibration, heat, wind and rain, or the like is generated or not. Alternatively, the predetermined attention information may indicate a degree of vibration, heat, or wind and rain.

The calculation unit 12 calculates a first index indicating a possibility that an event to be warned occurs, based on the attention information. That is, the calculation unit 12 may calculate an index indicating a probability that the event such as an accident to be warned occurs from the attention information. Alternatively, the calculation unit 12 may calculate an index indicating whether the event such as the accident to be warned occurs from the attention information. The first index calculated by the calculation unit 12 may be, for example, a binary or may be a ternary index or more.

More specifically, for example, in a case where the attention information acquisition unit 11 acquires the image data as the attention information, the calculation unit 12 may recognize a person or an automobile existing in the image data. In this case, for example, the calculation unit 12 may calculate the first index from a state where there is an abnormal crowd of people in the image data. Alternatively, in a case where the attention information acquisition unit 11 acquires a value of an acceleration sensor of the automobile as the attention information, the calculation unit 12 may calculate the first index if the value of the acceleration sensor exceeds a preset value. In this case, the automobile may transmit an identification number of the automobile or position information of the automobile, together with the value of the acceleration sensor.

In a case where the first index is equal to or greater than a first threshold, the control unit 13 specifies a warning region where there is a possibility that the event occurs based on the attention information. The first threshold is a value set to identify whether there is a possibility that the event related to the attention information is an accident or the like. That is, in a case where the first index is less than the first threshold, the information processing device 10 determines that the accident or the like does not occur. On the other hand, in a case where the first index is equal to or greater than the first threshold, the information processing device 10 determines that there is a possibility that the accident or the like occurs.

In a case where it is determined that there is a possibility that the accident or the like occurs from the acquired attention information, the control unit 13 specifies the warning region. At this time, the control unit 13 may specify a transmission source of the acquired attention information as the warning region. Alternatively, the control unit 13 may specify a region where there is a possibility that a predetermined event occurs, by analyzing the image data.

The control unit 13 outputs a movement control signal for giving an instruction to image the specified warning region to the moving system. The movement control signal includes information regarding a position of the warning region. The movement control signal may include information regarding a movement route of the moving system or a position to be a movement target. More specifically, for example, in a case where the attention information acquisition unit 11 acquires the image data as the attention information, and there is an abnormal crowd of people in this image data, the control unit 13 specifies the region of the crowd of people as the warning region and outputs the movement control signal for instructing the moving system to approach and image the crowd of people. Alternatively, in a case where the attention information acquisition unit 11 acquires the value of the acceleration sensor of the automobile as the attention information, it is assumed that the calculation unit 12 calculates the first index because the acceleration sensor exceeds a preset value. In this case, the control unit 13 specifies a position of the automobile that has transmitted a high value of the acceleration sensor in accordance with information transmitted from the automobile and specifies the specified position as the warning region. Moreover, the control unit 13 outputs the movement control signal for giving an instruction to image the specified warning region to the moving system.

The configuration of the information processing device 10 has been described above. With the configuration described above, the information processing device 10 can acquire the information of the warning region by using the moving system. That is, the information processing device 10 can acquire information used to suitably determine whether any accident or the like occurs or does not occur in the warning region. Therefore, the information processing device 10 can suitably monitor whether the predetermined event has occurred, in a predetermined communication network.

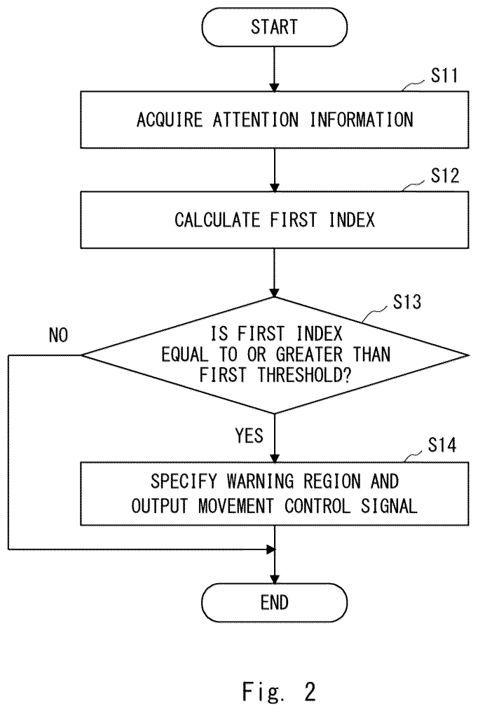

FIG. 2 is a flowchart of an information processing method executed by the information processing device 10 according to the first example embodiment. The flowchart illustrated in FIG. 2 starts, for example, upon the information processing device 10 detecting acquisition of the attention information.

First, the attention information acquisition unit 11 of the information processing device 10 acquires the predetermined attention information from the terminal that is directly and communicably connected within the communication network (step S11).

Next, the calculation unit 12 of the information processing device 10 calculates the first index indicating the possibility that the event to be warned occurs, from the acquired attention information (step S12).

Next, the control unit 13 of the information processing device 10 determines whether the calculated first index is equal to or greater than the first threshold (step S13). In a case where it is determined that the first index is equal to or greater than the first threshold (step S13: YES), the information processing device 10 proceeds to step S14. On the other hand, in a case where it is not determined that the first index is equal to or greater than the first threshold (step S13: NO), the information processing device 10 ends the series of processes.

In step S14, the control unit 13 of the information processing device 10 specifies the warning region having a possibility that the event occurs. Moreover, the control unit 13 outputs the movement control signal for giving an instruction to image the specified warning region to the moving system (step S14). After outputting the movement control signal to the moving system, the information processing device 10 ends the series of processes.

The information processing method executed by the information processing device 10 has been described above. With such processes, the information processing device 10 can acquire the information of the warning region having a possibility that the event such as an accident occurs.

The information processing device 10 may include a processor or a storage device as components not illustrated. The storage device included in the information processing device 10 includes a storage device including a non-volatile memory such as a flash memory or an SSD, for example. In this case, the storage device included in the information processing device 10 stores a computer program (hereinafter, also simply referred to as a program) for executing the above-described image processing method. In addition, the processor reads the computer program from the storage device into a buffer memory such as a dynamic random access memory (DRAM), and executes the program.

Each component included in the information processing device 10 may be implemented by dedicated hardware. Some or all of the components may be implemented by general-purpose or dedicated circuitry, a processor, or the like, or a combination thereof. These components may include a single chip or may include a plurality of chips connected via a bus. Some or all of the components of each device may be implemented by a combination of the above-described circuitry or the like and the program. Furthermore, as the processor, a central processing unit (CPU), a graphics processing unit (GPU), a field-programmable gate array (FPGA), or the like may be used. Note that the description regarding the configuration described here can also be applied to other devices or systems described below in the present disclosure.

As described above, according to the present example embodiment, it is possible to provide the information processing device, the information processing method, and the program that suitably monitor a situation of a predetermined region.

### Second Example Embodiment

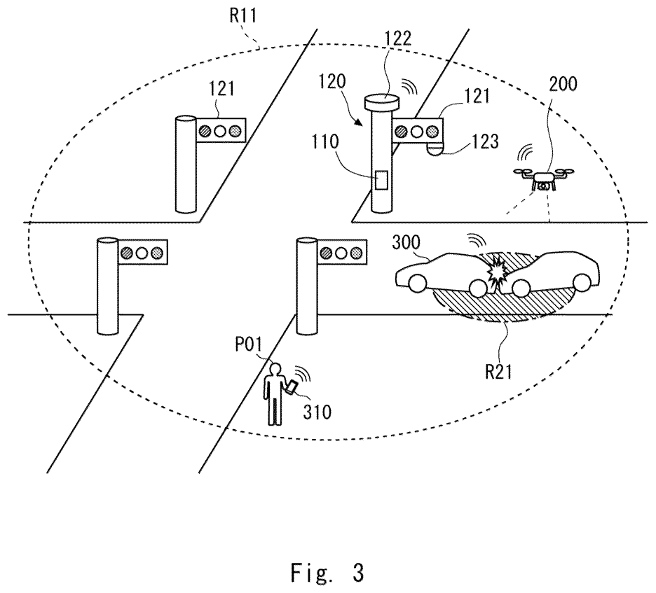

Hereinafter, a second example embodiment will be described. FIG. 3 is a diagram around a base station including an information processing device according to the second example embodiment. FIG. 3 illustrates a situation in a communication network R11. The communication network R11 is a range where a base station 110 installed at an intersection where vehicles and people pass can directly and wirelessly communicate with a predetermined terminal. In the communication network R11, a signal post 120, a traffic light 121, a moving system 200, a vehicle 300, and a communication terminal 310 exist.

The signal post 120 includes the base station 110, the traffic light 121, a drone port 122, and a camera 123, as main components. The base station 110 can directly and wirelessly communicate with the traffic light 121, the moving system 200, and the communication terminal 310. The base station 110 is communicably connected to the traffic light 121, the drone port 122, and the camera 123 in a wired or wireless manner. The drone port 122 may have a function for supplying power to the moving system 200.

The traffic light 121 is communicably connected to the base station 110 and may be controlled by the base station 110. The traffic light 121 may separately include a control device different from the base station 110. In this case, for example, in a case of determining that an event such as an accident has occurred, the base station 110 controls the traffic light 121.

The moving system 200 is an autonomous flying object including a camera that can image a landscape on the ground, in the air in the communication network R11. In the present disclosure, the autonomous flying object may be referred to as a drone. The moving system 200 is one embodiment of the moving system in the present disclosure. The moving system 200 stays at the drone port 122 to be able to take off and land, and moves to the vicinity of a warning region R21 in response to an instruction from the base station 110.

The vehicle 300 is an automobile that travels on a road. The vehicle 300 includes a terminal that can directly and wirelessly communicate with the base station 110. The vehicle 300 is in a situation of coming into contact with another vehicle behind. The vehicle 300 includes a sensor that detects a contact with the another vehicle and can transmit data of the sensor to the base station 110.

The communication terminal 310 is a terminal that is carried by a person P01 and has a communication function. The communication terminal 310 is, for example, a mobile phone, a tablet, a smartphone, a laptop computer, or the like. The communication terminal 310 may be glasses, a wristwatch, or the like having the communication function.

In the situation described above, the base station 110 may acquire attention information from the camera 123, the vehicle 300, and the communication terminal 310. The base station 110 may acquire the attention information from the moving system 200. The communication network R11 illustrated in FIG. 3 includes the warning region R21. An accident of the vehicle 300 occurs in the warning region R21.

In this case, for example, the vehicle 300 transmits data regarding an impact caused by the contact with the another vehicle, as the attention information. The base station 110 receives and acquires the attention information transmitted from the vehicle 300. Accordingly, the base station 110 specifies the warning region R21 and outputs a movement control signal for giving an instruction to image the warning region R21 to the moving system 200. The moving system 200 receives the movement control signal from the base station 110 and moves to the vicinity of the warning region R21 so as to image the warning region R21. Image data imaged and generated by the moving system 200 may be transmitted to the base station 110. After determining the occurrence of the accident from the image data received from the moving system 200, the base station 110 may control the traffic light 121. In this case, for example, the base station 110 controls the traffic light 121 so as not to increase a traffic volume in the warning region R21.

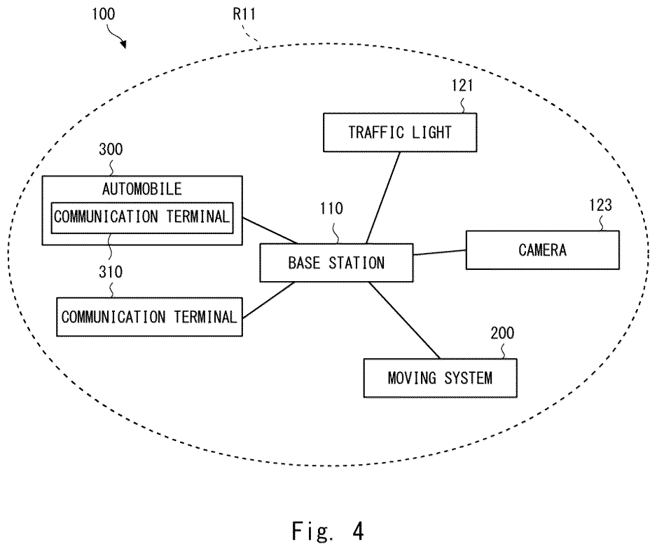

FIG. 4 is a block diagram of an information processing system 100 according to the second example embodiment. The information processing system 100 includes each component in the communication network R11 illustrated in FIG. 3. That is, the information processing system 100 includes the base station 110, the traffic light 121, the camera 123, and the moving system 200, as main components. The information processing system 100 may include the vehicle 300 and the communication terminal 310 existing in the communication network R11.

The base station 110 is communicably connected to the traffic light 121, the camera 123, the moving system 200, the vehicle 300, and the communication terminal 310 existing in the communication network R11. The base station 110 may acquire the attention information from the camera 123, the moving system 200, the vehicle 300, and the communication terminal 310 existing in the communication network R11. The base station 110 may control the traffic light 121, by using the information acquired from each component. Similarly, the base station 110 may control the moving system 200, by using the information acquired from each component.

The vehicle 300 may include the communication terminal 310. In this case, the vehicle 300 may be equipped with the communication terminal 310. The vehicle 300 may be integrated with the communication terminal 310. That is, the vehicle 300 may be one embodiment of the communication terminal 310.

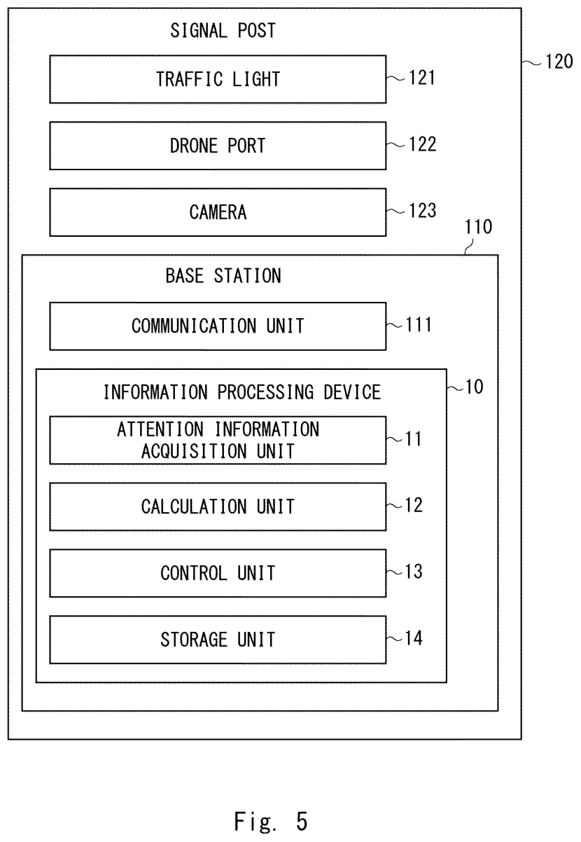

FIG. 5 is a block diagram of the signal post 120 including the information processing device 10. The signal post 120 illustrated in FIG. 5 relates to the signal post 120 in FIG. 3. The signal post 120 includes the traffic light 121, the drone port 122, the camera 123, and the base station 110, as main components.

The traffic light 121 is configured to display a traffic signal in response to the instruction from the base station 110. The traffic light 121 may be set to interlock with a traffic light outside the communication network R11. The drone port 122 may have a function for supplying power to the moving system 200 and a function for detecting whether there is the moving system 200. The camera 123 images a landscape around the signal post 120 and generates image data. The camera 123 may be configured to be able to tilt, pan, or zoom. The camera 123 supplies the image data generated by imaging, to the base station 110.

The base station 110 is set to be able to communicate with a predetermined terminal existing in the communication network R11. The base station 110 is, for example, a computer or a server to which a technology called Multi-access edge computing (MEC) is applied. The base station 110 includes a communication unit 111 and the information processing device 10, as main components. The communication unit 111 communicates with a communication terminal existing in the communication network R11. The communication unit 111 includes, for example, a wireless communication antenna, a signal processing circuit for transmitting a signal received from the information processing device 10, or the like. The base station 110 may further include communication means for communicating with outside of the communication network R11 such as the Internet or a public communication line.

Subsequently, the information processing device 10 according to the present example embodiment will be described. An attention information acquisition unit 11 according to the present example embodiment acquires the attention information from the communication terminal 310 by directly and wirelessly communicating with the communication terminal 310 that moves together with a vehicle or a person existing in a communication network of the base station 110. As a result, the information processing device 10 can acquire attention information regarding various events that occur in the communication network R11.

The attention information acquisition unit 11 according to the present example embodiment acquires image data imaged by the camera 123 installed in the signal post 120, as the attention information. As a result, the information processing device 10 can acquire the attention information from the camera 123 installed by using a system of the signal post 120. That is, the base station 110 can be additionally installed in the signal post 120 in which a monitoring camera is installed.

In a case of acquiring image data obtained by imaging the warning region R21 from the moving system 200, a calculation unit 12 according to the present example embodiment calculates a second index indicating a possibility that a predetermined event such as an accident occurs, by using the acquired image data. The second index indicates that the possibility that the predetermined event such as an accident occurs is higher than the first index described above. That is, for example, the second index indicates that the predetermined event such as an accident almost certainly occurs. Specifically, for example, the second index is a case where an image of a traffic accident is included in the image data obtained by imaging the warning region R21. By using the second index, the information processing device 10 can determine a situation in the warning region R21 more accurately.

In this case, a control unit 13 may output a traffic control signal to the traffic light 121 so as to prevent entry of a vehicle or a person in the warning region R21, in a case where the second index is equal to or greater than a second threshold which is higher than the first threshold. As a result, the information processing device 10 can suitably process the event in the warning region.

In this case, in a case where the second index is less than the second threshold, the control unit 13 may determine that the event such as an accident does not occur in the warning region R21. In this way, the information processing device 10 according to the present example embodiment can suitably process the event in the warning region.

The information processing device 10 includes a storage unit 14, in addition to the configuration described in the first example embodiment. The storage unit 14 may store a program that achieves the function according to the present disclosure, for example. The storage unit 14 may store the first threshold, the second threshold, or the like used by the control unit 13.

The control unit 13 according to the present example embodiment outputs the movement control signal to the moving system 200. As a result, the information processing device 10 can move the moving system 200 to the warning region R21 or the vicinity of the warning region R21. The information processing device 10 can cause the moving system 200 to image a landscape of the warning region R21. The control unit 13 may acquire image data of an image captured by a camera 203 provided in the signal post 120 as the attention information and calculate the first index from the image data of the camera 203. In this case, for example, in a case where the first index is equal to or greater than the first threshold, the control unit 13 outputs the movement control signal to the moving system 200.

In a case where the first index is equal to or greater than the second threshold which is higher than the first threshold, the control unit 13 may output the traffic control signal used to send a signal for preventing entry of a vehicle or a person in the warning region R21, to the traffic light 121 existing in the communication network. As a result, the information processing device 10 can suppress deterioration in the situation in a case where the predetermined event occurs.

The control unit 13 may output the traffic control signal to the traffic light 121 provided in the signal post 120 within the communication network. As a result, the information processing device 10 can control a movement of a vehicle or the like.

The control unit 13 may output the movement control signal for giving an instruction to image the warning region R21 from a position closer than a distance between the signal post 120 and the warning region R21, to the moving system 200. As a result, the information processing device 10 can suitably grasp the situation in the warning region R21 and determine whether the event such as an accident occurs.

The control unit 13 may instruct the moving system 200 to image the warning region R21 from a position away from a straight line connecting the signal post 120 and the warning region R21. As a result, the information processing device 10 can acquire, for example, information that cannot be acquired from the image data imaged by the camera installed in the signal post 120, from image data imaged by the moving system 200.

In a case of specifying an attention object related to the event based on the image imaged in the warning region R21, the control unit 13 may instruct the moving system 200 to image the attention object. Here, the attention object is, for example, a vehicle body of a vehicle that has caused an accident. Alternatively, the attention object may be a person. In this case, the attention object is a body of the person related to the accident or the like. As a result, the information processing device 10 can suitably acquire a state of the event such as an accident.

The control unit 13 may estimate a timing that the attention object arrives at the traffic light 121 in the communication network, by using the specified attention information and position information of the moving system 200 and output the traffic control signal to the traffic light 121 so as to present a traffic signal indicating “stop” based on the estimated timing. As a result, the information processing device 10 can suitably control a movement of the vehicle or the like and prevent the event from getting worse. In this case, the control unit 13 may estimate the timing that the attention object arrives at the traffic light 121 from the image captured by the camera 203 installed in the signal post 120. The control unit 13 may estimate the timing that the attention object arrives at the traffic light 121, by causing the above components to work together.

In a case where the specified attention object moves, the control unit 13 may instruct the moving system 200 to track and image the attention object. As a result, the information processing device 10 can suitably acquire the state of the event such as an accident.

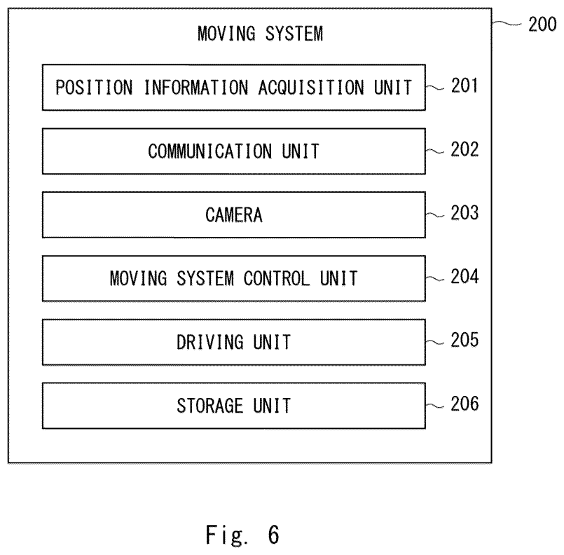

FIG. 6 is a block diagram of the moving system 200 according to the second example embodiment. The moving system 200 includes a position information acquisition unit 201, a communication unit 202, the camera 203, a moving system control unit 204, a driving unit 205, and a storage unit 206, as main components.

The position information acquisition unit 201 acquires the position information of the moving system 200, for example, by using a global navigation satellite system (GNSS), a position information acquisition system using Wi-Fi radio waves, or the like. The communication unit 202 has a function for performing direct wireless communication with the base station 110. That is, the communication unit 202 may include, for example, an antenna, a modulation circuit, a demodulation circuit, or the like. The camera 203 includes an objective lens, an imaging element, or the like used to image a landscape around the signal post 120 and generates image data. The camera 203 provides the generated image data to the information processing device 10.

The moving system control unit 204 includes an arithmetic device such as a CPU or an MCU and controls each component of the moving system 200. That is, for example, the moving system control unit 204 exchanges information with the base station 110 via the communication unit 202 and issues an instruction to each component of the moving system 200 in response to this. The driving unit 205 includes a motor for rotating a propeller that is movement means of the moving system 200. The storage unit 206 includes a non-volatile memory such as a flash memory or an SSD and stores identification information or the like of the moving system 200.

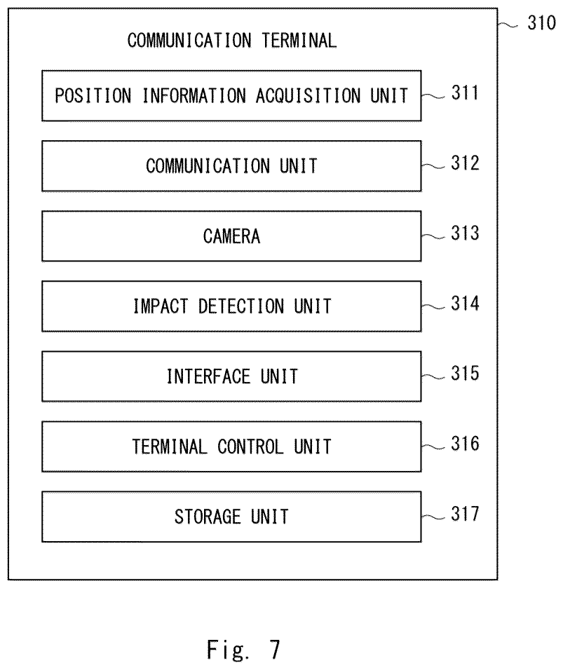

FIG. 7 is a block diagram of the communication terminal 310 according to the second example embodiment. The communication terminal 310 includes a position information acquisition unit 311, a communication unit 312, a camera 313, an impact detection unit 314, an interface unit 315, and a terminal control unit 316, as main components.

The position information acquisition unit 311 acquires the position information of the moving system 200, for example, by using the GNSS, the position information acquisition system using the Wi-Fi radio waves, or the like. The communication unit 312 includes an antenna, a circuit, or the like for performing direct wireless communication with the base station 110. The camera 313 captures an image in response to an operation of a user who operates the communication terminal 310. The impact detection unit 314 includes an acceleration sensor and detects that the communication terminal 310 receives an impact in a case where an acceleration equal to or greater than a predetermined value is detected. The interface unit 315 may include a button or a switch that accepts an operation of the user who operates the communication terminal 310.

The terminal control unit 316 includes an arithmetic device such as a CPU or an MCU and controls each component of the communication terminal 310. The terminal control unit 316 executes a program stored in a storage unit 317. The storage unit 317 includes a non-volatile memory and stores at least a program that achieves the function according to the present example embodiment.

The communication terminal 310 transmits predetermined attention information to the base station 110, with the configuration described above. The attention information indicates, for example, that an impact equal to or greater than the predetermined value is received. Alternatively, the attention information is image data generated by the camera 313. The attention information may include a signal indicating that the information is the attention information.

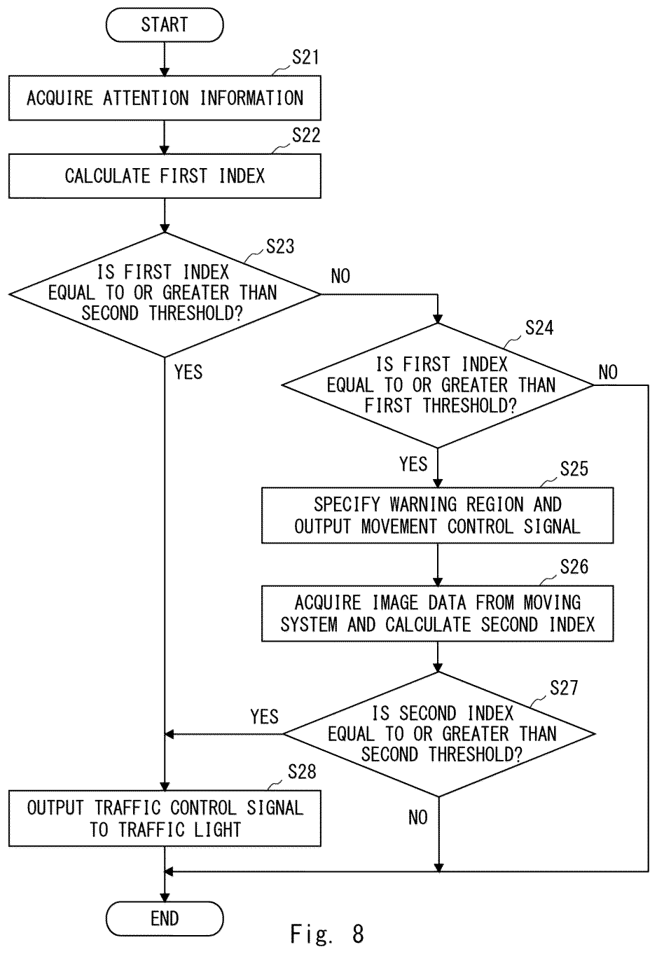

Next, a process executed by the information processing device 10 according to the present example embodiment will be described with reference to FIG. 8. FIG. 8 is a flowchart of an information processing method according to the second example embodiment.

First, the attention information acquisition unit 11 of the information processing device 10 acquires the predetermined attention information from a terminal that is directly and communicably connected within the communication network (step S21).

Next, the calculation unit 12 of the information processing device 10 calculates the first index indicating the possibility that the event to be warned occurs, from the acquired attention information (step S22).

Next, the control unit 13 of the information processing device 10 determines whether the calculated first index is equal to or greater than the second threshold (step S23). In a case where it is determined that the first index is equal to or greater than the second threshold (step S23: YES), the information processing device 10 proceeds to step S28. On the other hand, in a case where it is not determined that the first index is equal to or greater than the second threshold (step S23: NO), the information processing device 10 proceeds to step S24.

In step S24, the control unit 13 determines whether the first index is equal to or greater than the first threshold (step S24). In a case where it is determined that the first index is equal to or greater than the first threshold (step S24: YES), the information processing device 10 proceeds to step S25. In a case where it is not determined that the first index is equal to or greater than the first threshold (step S24: NO), the information processing device 10 ends the series of processes.

In step S25, the control unit 13 specifies the warning region and further outputs the movement control signal to the moving system 200 so as to image the warning region (step S25). Subsequently, the information processing device 10 acquires the image data from the moving system 200, and the calculation unit 12 calculates the second index by using the acquired image data (step S26).

Next, the control unit 13 determines whether the second index is equal to or greater than the second threshold (step S27). In a case where it is determined that the second index is equal to or greater than the second threshold (step S27: YES), the information processing device 10 proceeds to step S28. On the other hand, in a case where it is not determined that the second index is equal to or greater than the second threshold (step S27: NO), the information processing device 10 ends the series of processes.

In step S28, the control unit 13 outputs the traffic control signal related to the warning region, to the traffic light 121 (step S28).

Although the second example embodiment has been described above, the second example embodiment is not limited to the content described above. For example, there may be two or more moving system 200. The moving system 200 may be a robot or an autonomous vehicle that moves on the ground, instead of or in addition to the drone.

In step S27, in a case where the second index is, for example, equal to or greater than the first index and is less than the second index and it is difficult to clearly determine whether to output the traffic control signal, the information processing device 10 may instruct the moving system 200 to image the warning region R21 again. In addition, at this time, the information processing device 10 may instruct the moving system 200 to image the warning region R21 again, after changing an imaging position.

In step S27, the threshold used by the control unit 13 may be a third threshold different from the second threshold. That is, the threshold used to determine whether to output the traffic control signal regarding the warning region may be different from those in steps S23 and S27.

Although the second example embodiment has been described above, the information processing system 100 according to the present example embodiment is not limited to the above configuration. For example, the signal post 120 may be configured to be separated from the base station 110, without being integrated with the base station 110. The signal post 120 does not need to include the drone port 122. The signal post 120 does not need to include the camera 123.

According to the present example embodiment, it is possible to provide the information processing device, the information processing method, and the program that suitably monitor a situation of a predetermined region.

### Third Example Embodiment

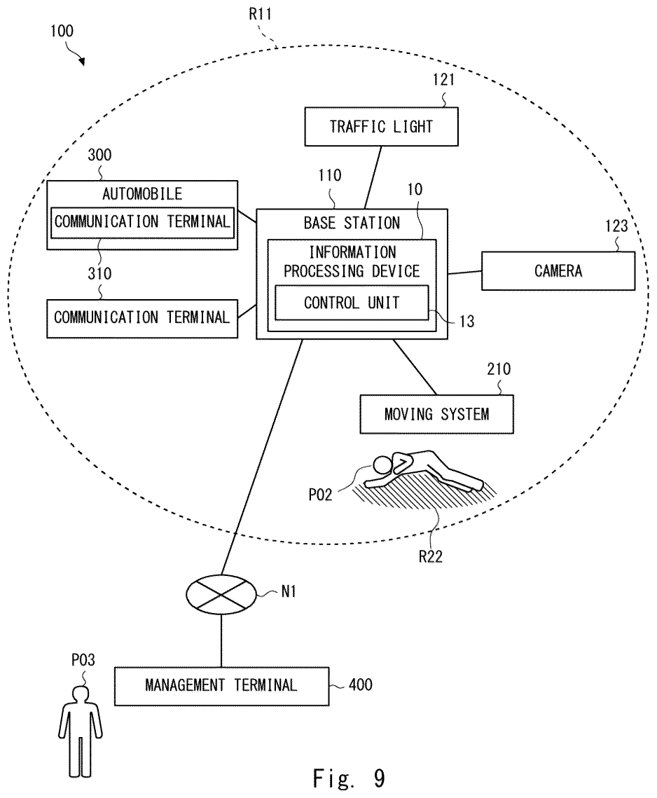

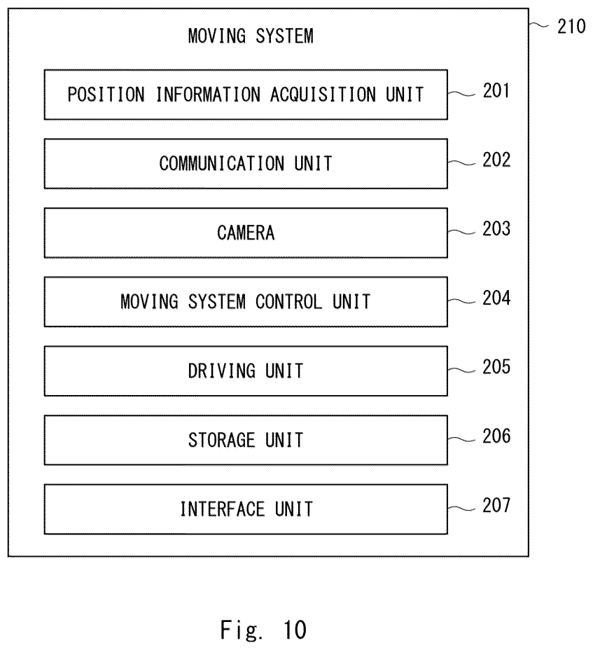

Next, a third example embodiment will be described. FIG. 9 is a block diagram of an information processing system according to the third example embodiment. An information processing system 100 according to the present example embodiment is connected to a network NI outside a communication network R11 and is communicably connected to a management terminal 400 via the network N1. The information processing system 100 according to the present example embodiment includes a moving system 210 instead of the moving system 200. The moving system 210 is different from the moving system 200 in that a predetermined interface unit is included.

A control unit 13 included in a base station 110 according to the present example embodiment outputs at least a part of attention information to the management terminal 400 that manages the control unit 13. As a result, an information processing device 10 can notify the management terminal 400 of a possibility that an event such as an accident occurs, via the network N1.

In a case where the moving system 210 collects sound in a warning region R21 and supplies the sound to the control unit 13, the control unit 13 outputs at least a part of sound data of the sound to the management terminal 400. As a result, the information processing device 10 can transmit details of an event to an administrator. The control unit 13 may output the sound data supplied to the control unit 13 by the management terminal 400, to the moving system 200. As a result, the information processing device 10 can issue a warning, a call, or the like to a warning region.

In the above situation, in the communication network R11 illustrated in FIG. 9, a person P02 falls down. The base station 110 specifies a warning region R22, and the moving system 210 approaches the warning region R22. Here, with the management terminal 400, an administrator P03 can communicate with the person (person P02) existing in the communication network R11, via the network N1, the base station 110, and the moving system 210.

The moving system 210 will be described with reference to FIG. 10. FIG. 10 is a block diagram of the moving system 210 according to the third example embodiment. The moving system 210 is different from the moving system 200 in that an interface unit 207 is included.

The interface unit 207 is means for notifying a person existing around the moving system 210 of information. The interface unit 207 is, for example, a speaker. The interface unit 207 may include a display or a light-emitting diode (LED), instead of or in addition to the speaker. As a result, the moving system 210 can notify the surroundings of the moving system 210 of information supplied from the management terminal 400 via the base station 110.

The interface unit 207 may include a microphone that acquires sound around the moving system 210. As a result, the moving system 210 can supply sound of a person existing around the moving system 210, to the management terminal 400 via the base station 110. Alternatively, the moving system 210 can supply sound in the warning region R22, to the management terminal 400 via the base station 110.

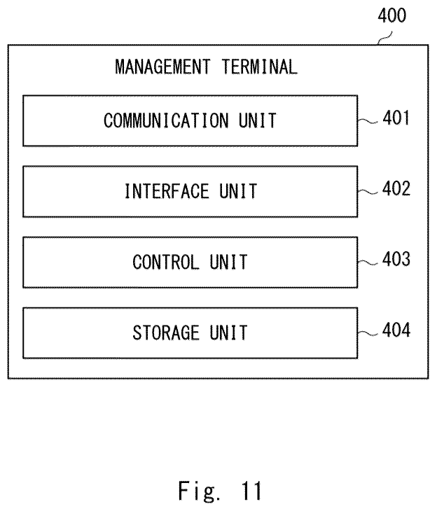

Next, the management terminal 400 will be described with reference to FIG. 11. FIG. 11 is a block diagram of the management terminal 400 according to the third example embodiment. The management terminal 400 includes a communication unit 401, an interface unit 402, a control unit 403, and a storage unit 404, as main components.

The communication unit 401 communicably connects the management terminal 400 to the network N1. The interface unit 402 includes a keyboard, a mouse, a microphone, or the like which are information input devices for the administrator P03 who uses the management terminal 400 to operate the management terminal 400. The interface unit 402 includes a display, a speaker, or the like for presenting information to the administrator P03. That is, the administrator P03 who uses the management terminal 400 in the present example embodiment can communicate with the person P02 existing near the moving system 210 by using the interface unit 402. The control unit 403 includes an arithmetic device for controlling each component of the management terminal 400. The storage unit 404 includes a non-volatile memory that stores a program or the like for the management terminal 400 to achieve the functions according to the present example embodiment.

The third example embodiment has been described above. According to the present example embodiment, it is possible to provide the information processing device, the information processing method, and the program that suitably monitor a situation of a predetermined region.

The above-described program can be stored and supplied to a computer using any of various types of non-transitory computer readable media. The non-transitory computer readable media include various types of tangible recording media. Examples of the non-transitory computer readable media include a magnetic recording medium (for example, a flexible disk, a magnetic tape, or a hard disk drive), a magneto-optical recording medium (for example, a magneto-optical disc), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM)). The program may be supplied to the computer using any of various types of transitory computer readable media. Examples of the transitory computer readable media include electrical signals, optical signals, and electromagnetic waves. The transitory computer readable media can supply the programs to the computer via a wired communication path such as an electric wire and an optical fiber or a wireless communication path.

### Example of Hardware Configuration

Hereinafter, a case where each functional configuration of an update information generation device and a static information management device in the present disclosure is achieved by a combination of hardware and software will be described.

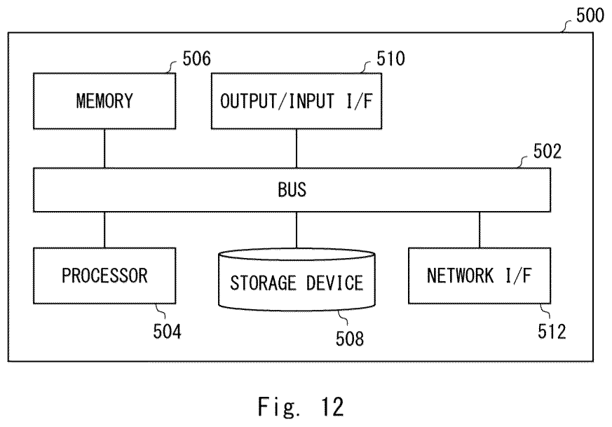

FIG. 12 is a block diagram illustrating a hardware configuration of a computer. The update information generation device and the static information management device in the present disclosure can achieve the above-described functions by a computer 500 including the hardware configuration illustrated in the drawing. The computer 500 may be a portable computer such as a smartphone or a tablet terminal or may be a stationary computer such as a PC. The computer 500 may be a dedicated computer designed to implement each device, or may be a general-purpose computer. The computer 500 can implement a desired function by installing a predetermined application.

The computer 500 includes a bus 502, a processor 504, a memory 506, a storage device 508, an input/output interface (I/F) 510, and a network interface (I/F) 512. The bus 502 is a data transmission path for the processor 504, the memory 506, the storage device 508, the input/output interface 510, and the network interface 512 to transmit and receive data to and from each other. However, the method of connecting the processor 504 and the like to each other is not limited to the bus connection.

The processor 504 is various processors such as a CPU, a GPU, or an FPGA. The memory 506 is a primary storage device implemented by using a random access memory (RAM) or the like.

The storage device 508 is an auxiliary storage device implemented using a hard disk, an SSD, a memory card, a read only memory (ROM), or the like. The storage device 508 stores a program for implementing a desired function. The processor 504 reads the program to the memory 506 and executes the program to implement each functional component of each device.

The input/output interface 510 is an interface connecting the computer 500 and an input/output device. For example, an input device such as a keyboard and an output device such as a display device are connected to the input/output interface 510.

The network interface 512 is an interface connecting the computer 500 to a network.

While the invention of the present application has been particularly shown and described with reference to example embodiments thereof, the invention of the present application is not limited to the above. It will be understood by those of ordinary skill in the art that various changes in form and details may be made therein without departing from the spirit and scope of the present application as defined by the claims.

Some or all of the above-described example embodiments may be described as the following Supplementary Notes, but are not limited to the following Supplementary Notes.

### Supplementary Note 1

An information processing device that controls a process performed by a base station that is capable of directly and wirelessly communicating with a moving system that includes a camera within a communication network of direct wireless communication, the information processing device including:
an attention information acquisition unit for acquiring predetermined attention information from a terminal that is directly and communicably connected within the communication network;
a calculation unit for calculating a first index indicating a possibility that an event to be warned occurs based on the attention information; and
a control unit for specifying a warning region having the possibility that the event occurs based on the attention information, in a case where the first index is equal to or greater than a first threshold, and outputting a movement control signal for giving an instruction to image the specified warning region, to the moving system.

### Supplementary Note 2

The information processing device according to supplementary note 1, in which the control unit outputs the movement control signal to the moving system that is an autonomous flying object including a camera that is able to image a landscape on a ground, in air.

### Supplementary Note 3

The information processing device according to supplementary note 1, in which the attention information acquisition unit acquires the attention information from a communication terminal by directly and wirelessly communicating with the communication terminal that moves together with a vehicle or a person existing within the communication network.

Supplementary Note 4

The information processing device according to supplementary note 1, in which the attention information acquisition unit acquires image data captured by a camera installed in the signal post, as the attention information.

### Supplementary Note 5

The information processing device according to any one of supplementary notes 1 to 4, in which, in a case where the first index is equal to or greater than a second threshold which is higher than the first threshold, the control unit outputs a traffic control signal for sending a signal that prevents entry of a vehicle or a person in the warning region, to a traffic light existing within the communication network.

### Supplementary Note 6

The information processing device according to supplementary note 5, in which the control unit outputs the traffic control signal to the traffic light provided in a signal post within the communication network.

### Supplementary Note 7

The information processing device according to supplementary note 6, in which
in a case of acquiring image data obtained by imaging the warning region from the moving system, the calculation unit calculates a second index indicating a possibility that the event occurs based on the image data, and
in a case where the second index is equal to or greater than the second threshold which is higher than the first threshold, the control unit outputs the traffic control signal to the traffic light to prevent the entry of the vehicle or the person in the warning region.

### Supplementary Note 8

The information processing device according to supplementary note 5, in a case where depending on supplementary note 4, in which the control unit outputs the movement control signal for giving an instruction to image the warning region from a closer position than a distance between the signal post and the warning region, to the moving system.

### Supplementary Note 9

The information processing device according to supplementary note 7, in which the control unit instructs the moving system to image the warning region from a position away from a straight line connecting the signal post and the warning region.

### Supplementary Note 10

The information processing device according to supplementary note 1, in which, in a case of specifying an attention object related to the event based on an image captured in the warning region, the control unit instructs the moving system to image the attention object.

### Supplementary Note 11

The information processing device according to supplementary note 10, in which, in a case where the specified attention object moves, the control unit instructs the moving system to track and image the attention object.

### Supplementary Note 12

The information processing device according to supplementary note 1, in which the control unit outputs at least a part of the attention information to a management terminal that manages the control unit.

### Supplementary Note 13

The information processing device according to supplementary note 12, in which, in a case where the moving system collects sound in the warning region and supplies the sound to the control unit, the control unit outputs at least a part of sound data of the sound to the management terminal.

### Supplementary Note 14

The information processing device according to supplementary note 13, in which the control unit outputs sound data supplied from the management terminal to the control unit, to the moving system.

### Supplementary Note 15

The information processing device according to supplementary note 10, in which the control unit estimates a timing that the attention object arrives at a traffic light within the communication network, based on specified attention information and position information of the moving system and outputs a traffic control signal to the traffic light in such a way as to present a traffic signal indicating “stop” based on the estimated timing.

### Supplementary Note 16

An information processing method performed by a computer that is capable of directly and wirelessly communicating with a moving system including a camera within a communication network of direct wireless communication, the information processing method including:
acquiring predetermined attention information from a terminal that is directly and communicably connected within the communication network;
calculating a first index indicating a possibility that an event to be warned occurs based on the attention information; and
specifying a warning region having the possibility that the event occurs based on the attention information, in a case where the first index is equal to or greater than a first threshold, and outputting a movement control signal for giving an instruction to image the specified warning region, to the moving system.

### Supplementary Note 17

A program for causing a computer that is capable of directly and wirelessly communicating with a moving system including a camera within a communication network of direct wireless communication, to execute an information processing method including:
acquiring predetermined attention information from a terminal that is directly and communicably connected within the communication network;
calculating a first index indicating a possibility that an event to be warned occurs based on the attention information; and
specifying a warning region having the possibility that the event occurs based on the attention information, in a case where the first index is equal to or greater than a first threshold, and outputting a movement control signal for giving an instruction to image the specified warning region, to the moving system.

Some or all of the elements (such as configurations and functions, for example) described in Supplementary Notes 2 to 15 depending from Supplementary Note 1 may depend from Supplementary Notes 16 to 17 as well with depending relationships similar to those of Supplementary Notes 2 to 15.

Some or all of the elements described in any Supplementary Note may be applied to various types of hardware, software, recording means for recording software, systems, and methods.

This application is based upon and claims the benefit of priority from Japanese patent application No. 2023-019536, filed on Feb. 10, 2023, the disclosure of which is incorporated herein in its entirety by reference.

### INDUSTRIAL APPLICABILITY The present disclosure can be used, for example, for a safety management device of a traffic network in a predetermined region or the like.

### REFERENCE SIGNS LIST

10 information processing device
11 attention information acquisition unit
12 calculation unit
13 control unit
14 storage unit
100 information processing system
110 base station
120 signal post
121 traffic light
122 drone port
123 camera
200 moving system
201 position information acquisition unit
202 communication unit
203 camera
204 moving system control unit
205 driving unit
206 storage unit
207 interface unit
210 moving system
300 vehicle
310 communication terminal
311 position information acquisition unit
312 communication unit
313 camera
314 impact detection unit
315 interface unit
316 terminal control unit
400 management terminal
401 communication unit
402 interface unit
403 control unit
404 storage unit
R11 communication network
R21 warning region
R22 warning region
N1 network
P01 person
P02 person
P03 administrator

What is claimed is:

1. An information processing device that controls a process performed by a base station that is capable of directly and wirelessly communicating with a moving system that includes a camera within a communication network of direct wireless communication, the information processing device comprising:
at least one memory storing instructions, and
at least one processor configured to execute the instructions to;
acquire predetermined attention information from a terminal that is directly and communicably connected within the communication network;
calculate a first index indicating a possibility that an event to be warned occurs based on the attention information; and
specify a warning region having the possibility that the event occurs based on the attention information, in a case where the first index is equal to or greater than a first threshold, and output a movement control signal for giving an instruction to image the specified warning region, to the moving system.

2. The information processing device according to claim 1, wherein the at least one processor is further configured to execute the instructions to output the movement control signal to the moving system that is an autonomous flying object including a camera that is able to image a landscape on a ground, in air.

3. The information processing device according to claim 1, wherein the at least one processor is further configured to execute the instructions to acquire the attention information from a communication terminal by directly and wirelessly communicating with the communication terminal that moves together with a vehicle or a person existing within the communication network.

4. The information processing device according to claim 1, wherein the at least one processor is further configured to execute the instructions to acquire image data captured by a camera installed in a signal post within the communication network, as the attention information.

5. The information processing device according to claim 1, wherein, in a case where the first index is equal to or greater than a second threshold which is higher than the first threshold, the at least one processor is further configured to execute the instructions to output traffic control signal for sending a signal that prevents entry of a vehicle or a person in the warning region, to a traffic light existing within the communication network.

6. The information processing device according to claim 5, wherein the at least one processor is further configured to execute the instructions to output the traffic control signal to the traffic light provided in a signal post within the communication network.

7. The information processing device according to claim 6, wherein the at least one processor is further configured to execute the instructions to:
in a case of acquiring image data obtained by imaging the warning region from the moving system, calculate second index indicating a possibility that the event occurs based on the image data, and
in a case where the second index is equal to or greater than the second threshold which is higher than the first threshold, output traffic control signal to the traffic light to prevent the entry of the vehicle or the person in the warning region.

8. The information processing device according to claim 5, wherein the at least one processor is further configured to execute the instructions to output the outputs-the movement control signal for giving an instruction to image the warning region from a closer position than a distance between a signal post within the communication network, in which a camera installed captures image data as the attention information, and the warning region, to the moving system.

9. The information processing device according to claim 7, wherein the at least one processor is further configured to execute the instructions to instruct the moving system to image the warning region from a position away from a straight line connecting the signal post and the warning region.

10. The information processing device according to claim 1, wherein, in a case of specifying an attention object related to the event based on an image captured in the warning region, the at least one processor is further configured to execute the instructions to instruct the moving system to image the attention object.

11. The information processing device according to claim 10, wherein, in a case where the specified attention object moves, the at least one processor is further configured to execute the instructions to instruct the moving system to track and image the attention object.

12. The information processing device according to claim 1, wherein the at least one processor is further configured to execute the instructions to output at least a part of the attention information to a management terminal that manages the control unit.

13. The information processing device according to claim 12, wherein, in a case where the moving system collects sound in the warning region and supplies the sound to the information processing device, the at least one processor is further configured to execute the instructions to output at least a part of sound data of the sound to the management terminal.

14. The information processing device according to claim 13, wherein the at least one processor is further configured to execute the instructions to output sound data supplied from the management terminal to the information processing device, to the moving system.

15. The information processing device according to claim 10, wherein the at least one processor is further configured to execute the instructions to estimate means estimates a timing that the attention object arrives at a traffic light within the communication network, based on the specified attention information and position information of the moving system and output a traffic control signal to the traffic light in such a way as to present a traffic signal indicating “stop” based on the estimated timing.

16. An information processing method performed by a computer that is capable of directly and wirelessly communicating with a moving system including a camera within a communication network of direct wireless communication, the information processing method comprising:
acquiring predetermined attention information from a terminal that is directly and communicably connected within the communication network;
calculating a first index indicating a possibility that an event to be warned occurs based on the attention information; and
specifying a warning region having the possibility that the event occurs based on the attention information, in a case where the first index is equal to or greater than a first threshold, and outputting a movement control signal for giving an instruction to image the specified warning region, to the moving system.

17. The information processing method according to claim 16, further comprising outputting the movement control signal to the moving system that is an autonomous flying object including a camera that is able to image a landscape on a ground, in air.

18. The information processing method according to claim 16, further comprising acquiring the attention information from a communication terminal by directly and wirelessly communicating with the communication terminal that moves together with a vehicle or a person existing within the communication network.

19. The information processing method according to claim 16, further comprising acquiring image data captured by a camera installed in a signal post within the communication network, as the attention information.

20. A non-transitory computer-readable medium storing a program that causes a computer that is capable of directly and wirelessly communicating with a moving system including a camera within a communication network of direct wireless communication, to execute an information processing method comprising:
acquiring predetermined attention information from a terminal that is directly and communicably connected within the communication network;
calculating a first index indicating a possibility that an event to be warned occurs based on the attention information; and
specifying a warning region having the possibility that the event occurs based on the attention information, in a case where the first index is equal to or greater than a first threshold, and outputting a movement control signal for giving an instruction to image the specified warning region, to the moving system.
